(19) United States
(12) Patent Application Publication
(10) Pub. No.: US 2010/0243776 A1
(43) Pub. Date: Sep. 30, 2010

(54) DEVICE FOR REDUCING FIBROUS PRODUCTS

(75) Inventor: John Campbell FORSTER, Ajax (CA)

Correspondence Address: PRASS LLP, 2661 Riva Road, Bldg. 1000, Suite 1044, ANNAPOLIS, MD, 21401, US

(73) Assignee: VERNACARE LIMITED, Lancashire (GB)

(21) Appl. No.: 12/719,460

(22) Filed: Mar. 8, 2010

(30) Foreign Application Priority Data
Mar. 6, 2009 (GB) 0903881.1

(51) Int. Cl. B02C 23/00

(52) U.S. Cl. 241/39

(57) ABSTRACT

A macerator comprises a housing, an opening in the housing providing access to its interior, an outlet located at a level below the opening and spray means for directing a directional jet of pressurised fluid into the container The spray means is controllable to vary the direction of the jet of pressurised fluid.

### PRIORITY INFORMATION

This application claims foreign priority benefits under U.S.C. §119(a)-(d) to UK0903881.1, filed Mar. 6, 2009, which is hereby incorporated by reference in its entirety.

### BACKGROUND

The present invention relates to devices for reducing fibrous products. In particular, but not exclusively, the invention relates to macerators for reducing soiled paper pulp bedpans, urine bottles and the like to small particles, to enable them to be discharged into a sewer.

In the healthcare industry, there are increasing moves towards providing each patient with an individual room having all of the necessary facilities such as toilet, wash basin, shower and the like. Not only is this desirable from a privacy and treatment point of view, but the reduction in shared facilities significantly reduces the incidence of cross infection.

The use of moulded paper pulp bedpans, urine bottles and the like has been known for many years. After use, the soiled article is disposed of in a macerator. A typical macerator takes the form of a generally cylindrical, upright drum having a rotatable cutting blade disposed at its base and rotatable by means of an electric motor. In use, an article to be macerated is placed in the drum and a lid closes off the aperture. During the operation cycle, water is fed into the container and the motor is operated, causing the blade to rotate. The articles within the macerator are reduced to small particles, at a size which allows them to be discharged into a sewer.

It would be extremely convenient if individual patient rooms could be provided with their own macerator, since this would avoid the need for the soiled article to be taken to a sluice room, where the macerator is normally located, and in addition would also assist in preventing cross-infection. However, the size of typical macerators makes this impractical in most circumstances.

Furthermore, there is a clinical desired to determine the weight of the contents of the soiled container. Whilst it is possible to weigh soiled containers at the moment, this is often not practical since the weighing apparatus would normally be located in a sluice room, in the vicinity of the macerator, which is normally remote from the patient and his or her records.

### SUMMARY

In accordance with a first aspect of the present invention, a macerator comprises a housing, an opening in the housing providing access to its interior, an outlet located at a level below the opening and spray means for directing a directional jet of pressurised fluid into the container, the spray means being controllable to vary the direction of the jet of pressurised fluid.

In contrast to the prior art macerators, in which the article is reduced by means of a rotating blade, in the present invention the article is reduced by the impacts of pressurised fluid, e.g. water, directly onto the article.

Preferably, the spray means is movably mounted with respect to the housing and wherein the macerator further comprises powered means for moving the spray means. More preferably, the spray means is rotatably mounted with respect to the housing.

In a preferred embodiment the spray means produces a linear jet of pressurised fluid and wherein the axis of rotation of the spray means is not aligned with the direction of the jet of pressurised fluid. The axis of rotation of the spray means is inclined to the direction of the jet of pressurised fluid.

Preferably, the spray means directs the jet of pressurised fluid downwardly.

The macerator preferably comprises a plurality of spray means.

Preferably, the outlet is continuously open.

The macerator may further comprising a toilet.

There may be sensor means which determine whether the toilet is deemed to be in use and control means for inhibiting the macerating function of the macerator in the event that the toilet is deemed to be in use.

The macerator may further comprise a contactless switch for initiating the macerating function.

The macerator may further comprise weighing means for weighing an article to be reduced.

The macerator may also comprise means for identifying an article to be reduced.

In accordance with a second aspect of the present invention, a macerator comprises a housing, an opening in the housing providing access to its interior, an outlet located at a level below the opening, reduction means within the housing for reducing a maceratable article and weighing means for weighing an article to be reduced.

By incorporating a weighing means within the macerator, it is much more convenience to weigh the soiled article, particularly if the macerator is located in an individual patient's room.

Preferably, the weighing means is located within the housing.

In one embodiment, the weighing means comprises a support plate.

Preferably, the support plate is located within the housing.

In a preferred embodiment, the support plate is displaceable from an article support position to a position in which the article is not supported and is allowed to fall towards the area where it is to be reduced.

Preferably, the article support position of the support plate is substantially horizontal.

Preferably, the support plate is pivotally mounted, preferably by means of an electric motor.

In another embodiment, the weighing means comprises scale means, e.g. electronic scale means.

Preferably, the opening is releasably closable.

The macerator may further comprising means for identifying the article to be macerated.

Preferably, the weight of the identified article is subtracted from the total weight of the weighed article, to give the weight of its contents.

The means for identifying an article to be macerated may comprise a scanner for reading a bar code associated with the article to be macerated.

The means for identifying an article to be macerated may comprise means for reading information from a radio frequency identification (RFID) tag or barcode on the article to be macerated.

In accordance with a third aspect of the present invention, a macerator comprises a housing, an opening in the housing providing access to its interior, an outlet located at level below the opening, reduction means within the housing for reducing maceratable articles and means for identifying an article to be macerated.

By providing means for identifying the article to be macerated, the likelihood of an article which cannot be macerated being placed in to the macerator is greatly reduced. In addition, if the nature of the article is identified, it is possible to monitor the usage, and stocks of, the articles in question.

In accordance with a fourth aspect of the present invention, a macerator comprises a housing, an opening in the housing providing access to its interior, an outlet located at a level below the housing, reduction means within the housing for reducing macerated articles, reduction means within the housing for reducing maceratable articles and toilet means located externally of the housing.

By providing a combined toilet and macerator, the space required is greatly reduced, which therefore allows the macerator to be fitted into more individual patients' rooms.

The macerator may further comprise sensor means which determine whether the toilet is deemed to be in use and control means for inhibiting the macerating function of the macerator in the event that the toilet is deemed to be in use.

Preferably the products from the outlet of the housing and from the toilet are discharged into a common outlet.

In accordance with a fifth aspect of the present invention, the macerator comprises a housing, an opening in the housing providing access to its interior, reduction means within the housing for reducing macerated articles and an outlet at a level below the opening, the outlet being continuously open.

By having a continuously open outlet, the operation and control of the macerator is simplified, which reduces the size and cost of the macerator.

### BRIEF DESCRIPTION OF THE DRAWINGS

By way of example only, a specific embodiment of the present invention will now be described, with reference to the accompanying drawings, in which:—

FIG. 1 is a perspective view of an embodiment of macerator in accordance with the present invention;

FIG. 2 is a front view of the macerator of FIG. 1;

FIG. 3 is a side view of the macerator of FIG. 1;

FIG. 4 is a rear view of the macerator of FIG. 1;

FIG. 5 is a perspective view of a macerating unit housed within the macerator of FIG. 1;

FIGS. 6 and 7 are vertical cross-sections through the macerating unit of FIG. 5, looking in the direction of arrows VI-VI and VII-VII respectively;

FIG. 8 is a detailed perspective view of a spray head of the macerating unit of FIG. 5; and

FIG. 9 is an exploded perspective view of the macerating unit shown in FIG. 5.

### DETAILED DESCRIPTION

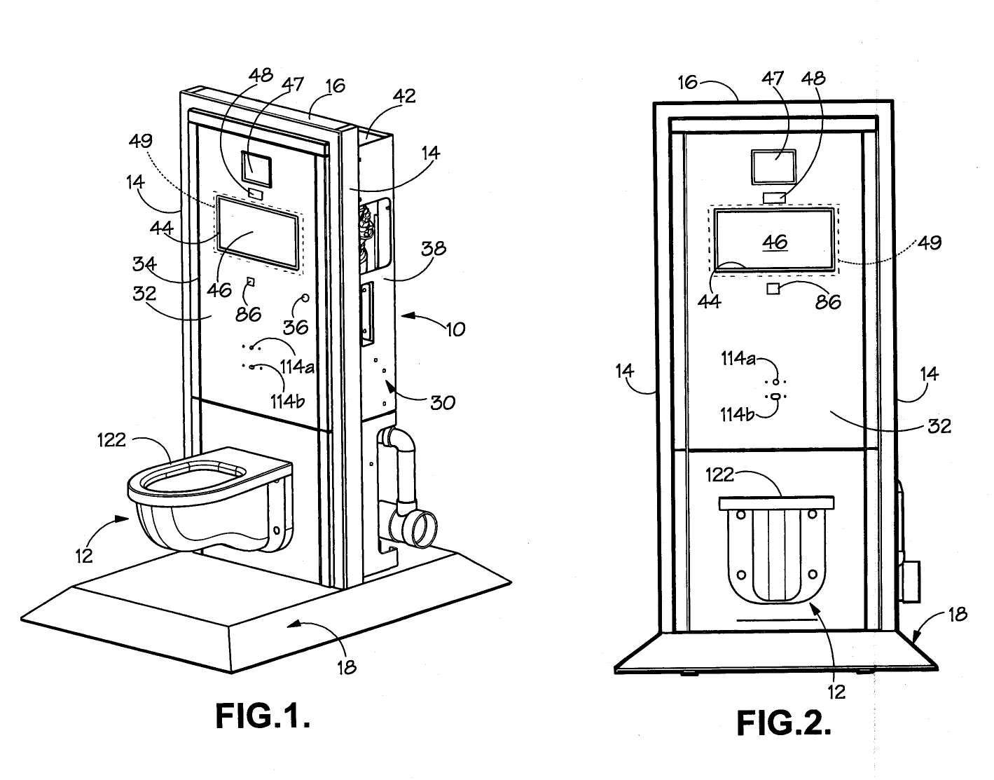

With reference to FIGS. 1 to 4, a disposal unit comprises a macerator generally indicated at 10, from the lower front portion of which a toilet bowl 12 projects. The macerator 10 is supported by a frame comprising two straight parallel upright frame members 14 and a cross member 16 extending horizontally between the upper ends of the upright members 14. The upright members 14 are mounted on a support plinth 18. As best seen in FIG. 4, the outlet 20 from the macerator 10 and the outlet 22 from the toilet bowl 12 are connected to a common outlet pipe 24, which is connected in a conventional manner to a normal drain.

The macerator 10 comprises a cabinet 30 mounted above the level of the toilet bowl 12. The cabinet 30 is formed from pressed sheet metal and comprises a rectangular front wall 32 which is hingedly mounted along one vertically-arranged edge 34. The front wall 32 is normally locked in the closed position by means of a lock 36 but may be opened to afford access to the interior of the cabinet 30, if desired. The cabinet 30 further comprises two planar side walls 38 extending generally perpendicularly from the closed front wall 32, a rear rectangular wall 40 (having a rectangular access aperture 41 therein) extending parallel to the closed front wall 32 between the vertical rear edges of the side walls 38 and a rectangular top wall 42 extending perpendicularly to the closed front wall 32, the side walls 38 and the rear wall 40.

The front wall 32 is provided with a rectangular aperture 44 located approximately ⅓ of the way down. The rectangular aperture 44 receives a complementarily-shaped hingedly mounted hopper door 46 which forms part of a macerator unit 50 located within the macerator housing 10.

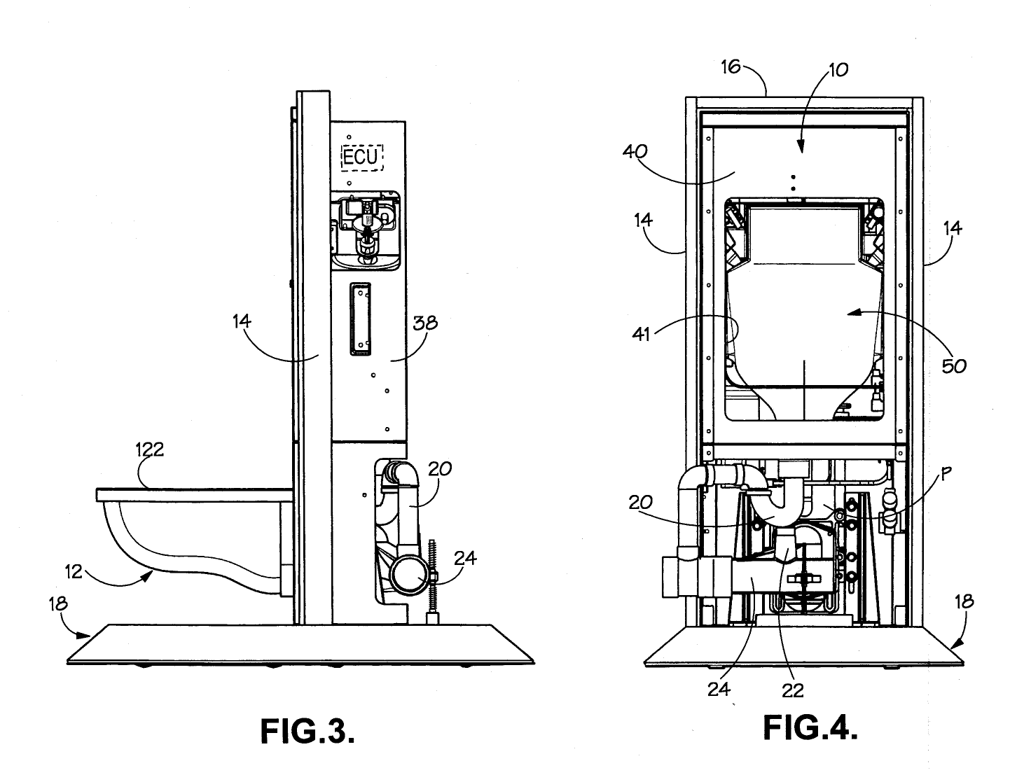

A touch-screen display 47 is located on the front wall 32 above the hinged door 46 and a bar-code scanner 48 is located between the hinged door 46 and the touch-screen display 47. A radio frequency identification (RFID) tag detector 49 is also located around the periphery of the aperture 44, on the rear face of the front wall 32. An electronic control unit ECU (FIG. 3) which controls the operation of the macerator is located immediately behind the display 47.

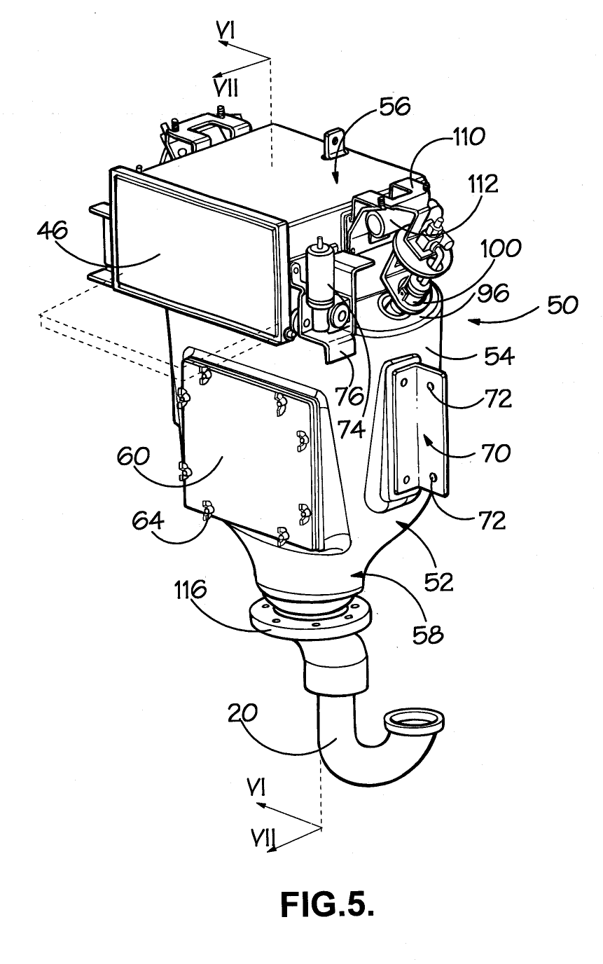

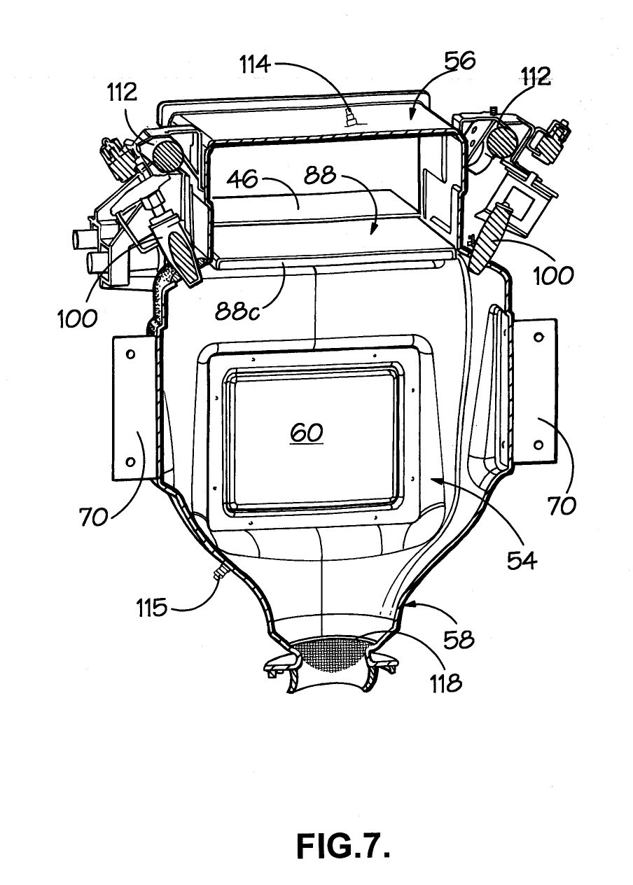

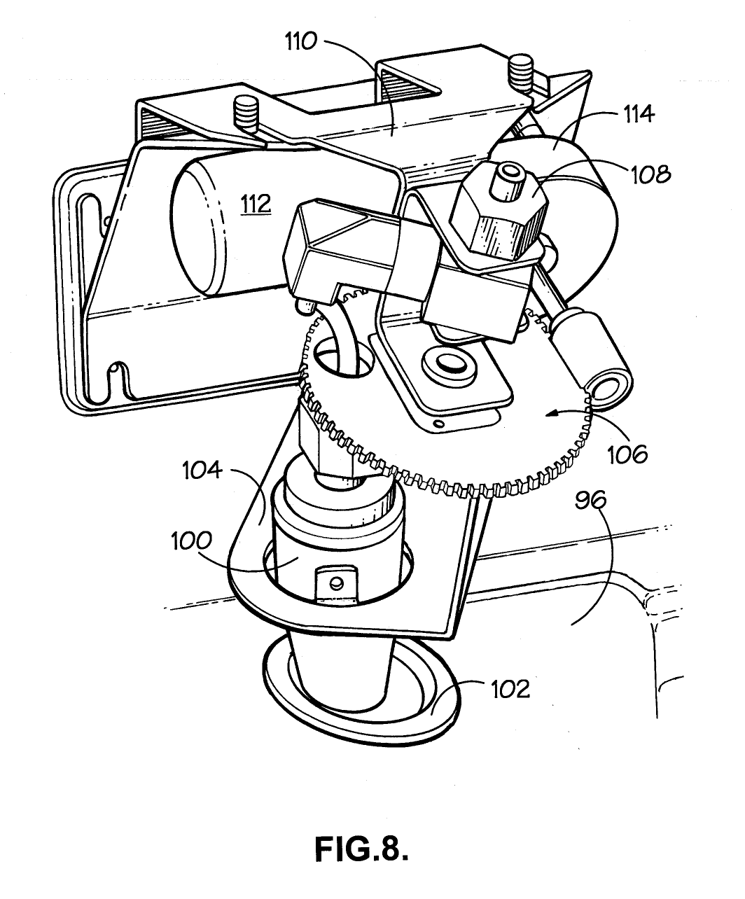

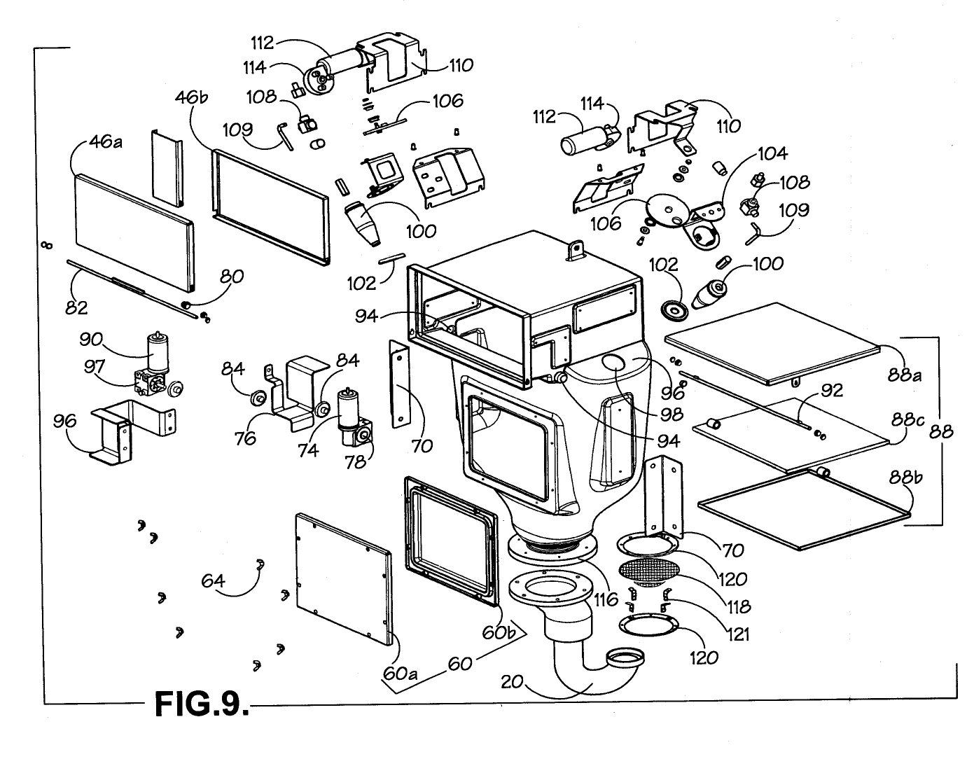

The macerator unit 50 is illustrated in more detail in FIGS. 5 to 9. The macerator unit 50 comprises a stainless steel hopper 52 comprising a central macerating portion 54 having a loading portion 56 mounted at its upper end and a tapered discharge portion 58 mounted at its lower end. The discharge pipe 20 described previously is connected to the lower end of the discharge portion 58.

As best seen in FIGS. 5 to 9, the macerating portion 54 is generally rectangular in cross section and is provided with a releasably mountable front access door 60 to allow access to the interior of the macerator unit 50 by authorised personnel, if desired. The front access door 60 is formed from inner and outer leaves 60a, 60b and is held in place by a plurality of wing nuts 64 around its periphery. A mounting bracket 70 is also securely attached to each side of the macerating portion 54 and is provided with apertures 72 for attaching the macerator to the upright members 14 of the supporting frame.

As explained previously, the upper loading portion 56 of the macerating unit 50 comprises an access door 46 (comprising front and rear door sheets 46a, 46b) which is hingedly mounted along its lower edge. The access door 46 is pivotable downwardly from the position shown in full lines in FIG. 5 through 90° to the position shown in dotted lines in FIG. 5, in which it projects forwardly through the rectangular aperture 44 in the front wall 32 of the housing into a horizontal position. The door is pivoted by means of an electric motor 74 controlled by the electronic control unit ECU arranged adjacent to one upright edge of the access door 46. The motor is mounted on a mounting bracket 76 which is secured to the outer face of the loading portion 56 of the macerator unit 50. The output of the motor 74 is rotational, and is connected to a worm drive 78 which transmits rotational motion to a gear 80 mounted on the access door axle 82 via two transmission gears 84. The motor 74 is a reversible motor and is adapted to pivot the access door 46 from the closed position, shown in full lines in FIG. 5, through 90° to the open position, shown in dotted lines in FIG. 5, upon actuation of the proximity sensor 86 located in the front wall 32 of the macerator housing 30 immediately below the access door 46.

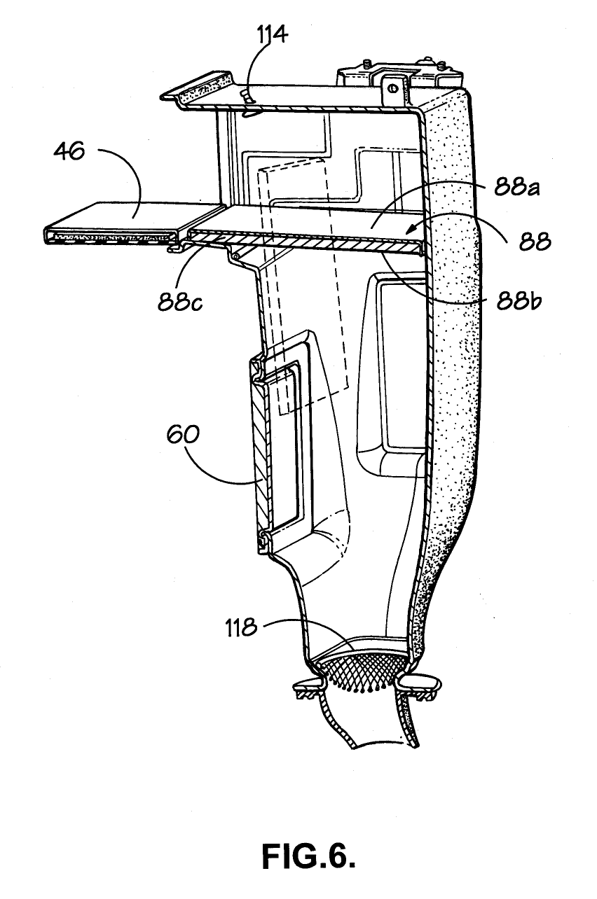

The interface between the loading portion 56 and the macerating portion 54 of the macerating unit 52 is defined by an upper, pivotally mounted rectangular weighing plate 88. The weighing plate 88 is pivotable by means of an electric actuating motor 90, controlled by the electronic control unit ECU, between a horizontal position shown in full lines FIG. 6 and a vertical position shown in dotted lines in FIG. 6. The weighing plate 88 is formed from upper and lower leaves 88a, 88b, mounted on either side of an axle 92 which passes through mounting holes 94 located on either side of, and immediately behind, the access door 46, and an electronic scale 88c, which outputs a signal to the electronic control unit ECU, sandwiched between the upper and lower leaves 88a, 88b. The actuating motor 90 mounted on a mounting bracket 96 located on the opposite side of the loading portion to the access door motor 74. As for the access door motor 74, the output of the motor 92 is rotational and is transmitted via an integral worm drive 97 to a gear 98 which is rotationally fixed with respect to the weighing plate mounting axle. Consequently, actuation of the motor 90 causes the weighing plate 88 to pivot between the horizontal position (in which it is level with the open access door 46) and a vertical position.

The upper portions of the side walls of the macerating portion 54 are formed into two shoulders 96 located one on either side of the macerating unit. Only one shoulder 96 is visible in FIGS. 5 and 6, but the two shoulders are mirror images of each other. Each of the shoulder portions is provided with a circular aperture 98 which receives a rotatable high pressure spray head 100 is adapted to inject a highly-directional jet of high pressure water into the macerating portion 54 below the weighing plate 88 in order to reduce soiled paper pulp articles into particles which are sufficiently small to be discharged into the normal drainage system, as will be explained.

Each of the high pressure spray heads 100 is rotatably mounted within the circular aperture 98. Each spray head 100 is received in a spray head grommet diaphragm 102 which allows the spray head 100 to rotate and simultaneously change their axis of orientation, as will be explained.

Each spray head 100 is mounted on a mounting bracket 104 which is in turn secured to a rotary gear 106. A high pressure swivel fitting 108 is secured to, and is rotatable with, the rotary gear 106 and supplies pressurised water to the spray head 100 via an angled spray tube 109. The spray head rotary gear 106 is rotatably mounted by means of a mounting bracket 110 secured to the outer face of the loading portion 56 of the macerator unit 50.

Each spray head rotary gear 106 is rotatable through a 140° arc by means of a low voltage reversible drive motor 112, controlled by the electronic control unit ECU via a worm gear 114 which is engaged with the spray head rotary gear 106. Actuation of the motors 112 therefore causes the spray heads 100 to be displaced rotationally to and fro through a 140° displacement. The connection of the high pressure swivel fittings 108 allows the spray heads 100 to be supplied with high pressure water irrespective of their position and during rotation.

However, each spray head 100 is mounted on its mounting bracket 104 connected to the rotary gear 106 such that the direction of the jet of water produced by the spray head is inclined to the rotational axis of the rotary gear 106 to which it is fixed and with which it rotates.

Consequently, as the rotary gear 106 rotates by operation of the motor 112, the spray head as it rotates delivers high pressure water in a helical pattern into the macerating portion 54 of the macerating unit 50 below the weighing plate 22. Consequently, high pressure water, as will be explained, is directed to all areas of the interior of the macerating unit 50.

As explained previously, the spray head grommet diaphragms 102 seal the spray heads 100 with respect to the apertures 98 in the outwardly projecting shoulders 46 but simultaneously allow rotation of, and change in the inclination of, the spray heads 110 with respect to the macerator unit.

A first fixed rinsing spray head 114 is mounted on the upper wall of the macerator loading portion 56 and is arranged to produce a downwardly-directed divergent spray of water over the inner walls of the loading portion 56. A second fixed rinsing spray head 115 is mounted at the junction of the macerating portion 56 and the discharge portion 58 and is arranged to produce an upwardly-directed divergent spray of water over the inner walls of the macerating portion 54.

As best seen in FIGS. 6 to 8, the lowermost end of the discharge portion 58 of the macerator unit 30 is formed into a mounting flange 116 which receives a mesh filter 118 retained between upper and lower filter mounting rings 120 and by retaining clips 121.

It should also be noted that the undersurface of the hingedly-mounted toilet seat 122 of the toilet bowl 12 is provided with a pressure sensor (not visible) which, as will explained, prevents operation of the macerator 10 if the pressure detected by the sensor indicates that a person is sitting on the toilet seat, which indicates that the toilet is in use. Similarly, if the pressure sensor detects no pressure, it is an indication that the toilet seat 122 has been lifted and that consequently the toilet may be in use, and again operation of the macerator is prevented.

The toilet 12 can be used in an entirely conventional manner. A proximity sensor 114 comprising an infrared emitter 114a and infrared detector 114b is provided in the lower part of the front wall 32 of the macerator unit to flush the toilet automatically after use.

However, the unit can also be used to dispose of soiled paper pulp bedpans, urine bottles, sputum bowls and the like when desired. In order to use the macerator function of the unit, an operator approaches the unit with the soiled article to be disposed of. The operator passes his or her hand over the motion sensor 84 located on the front of the macerator below the access door 46. This results in actuation of the motor 74 controlling pivoting of the access door 46 which causes the door to pivot downwardly into the open, horizontal position, unless the toilet seat sensor indicates that the toilet is use (either by means of an increased pressure, indicating the presence of a person seating on the toilet seat or a reduced pressure, indicating that the toilet seat has been lifted).

Opening of the access door 46 also actuates the bar code scanner 48. If the article to be macerated bears a bar code, the code is scanned, which identifies the type and weight of the article when unsoiled. If the article has no bar code or if it is not possible to read the bar code, the details of the article can be input manually (from a list of possible articles) suing the touch-screen display 46. The control means of the macerator will then be able to determine the weight of the article when unsoiled.

Alternatively, if the article to be macerated is fitted with a radio frequency identification (RFID) tag, the article can be identified as it is passed through the open access door 46.

The soiled article is then placed into the loading portion 56 of the macerator unit 50, whereupon it rests upon the weighing plate 88 which is at that stage in the horizontal position. The weight of the soiled article is then determined by the electronic scale 88c which outputs a signal corresponding to the weight to the electronic control unit ECU. The electronic control unit ECU subtracts the dry weight of the utensil, giving the weight of its contents. The weight of the contents is displayed on the screen and is stored into the memory of the control unit.

The access door 46 then closes after a predetermined period (e.g. 5 seconds) and when the door is closed the weighing plate 88 is pivoted by actuation of its actuating motor, which allows the soiled article to fall into the macerating part 54 of the macerator unit 50, where it comes to rest against the inner face of the enclosing walls. The weighing plate 88 is then returned to the horizontal position, at which point the electronic control unit ECU controls a pump P and valves (not shown) to connect a high pressure water supply to the spray nozzles 100 is switched on and simultaneously the actuating motors 112 are operated to cause the spray heads 100 to move back and forth, as described previously, which delivers high pressure water in a helical pattern downwardly towards the article within the macerating portion 54. The interaction of the high pressure water jets with the article reduces the article to particles of a size which can pass through the filter 118 of the discharge plate 58 and thereby pass out of the macerating unit, into the outlet pipe 20 and the common drain 24.

After a predetermined period, the water supply to the spray hoods 100 ceases and the actuating motors stop. Rinsing water is then supplied to the rinsing spray heads 114, 115 to rinse the interior of the macerator unit. The macerator is then ready for re-use.

The invention is not restricted to the details of the foregoing embodiment.

What is claimed is:

1. A macerator comprising:
a housing,
an opening in the housing providing access to its interior;
an outlet located at a level below the opening; and
spray means for directing a directional jet of pressurised fluid into the container, the spray means being controllable to vary the direction of the jet of pressurised fluid.

2. The macerator as claimed in claim 1, wherein the spray means is movably mounted with respect to the housing and wherein the macerator further comprises powered means for moving the spray means.

3. The macerator as claimed in claim 2, wherein the spray means is rotatably mounted with respect to the housing.

4. The macerator as claimed in claim 3, wherein the spray means produces a linear jet of pressurised fluid and wherein the axis of rotation of the spray means is not aligned with the direction of the jet of pressurised fluid.

5. The macerator as claimed in claim 4, wherein the axis of rotation of the spray means is inclined to the direction of the jet of pressurised fluid.

6. The macerator as claimed in claim 1, wherein the spray means directs the jet of pressurised fluid downwardly.

7. The macerator as claimed in claim 1, comprising a plurality of spray means.

8. The macerator as claimed in claim 1, wherein the outlet is continuously open.

9. The macerator as claimed in claim 1, further comprising a toilet.

10. The macerator as claimed in claim 9, further comprising sensor means which determine whether the toilet is deemed to be in use and control means for inhibiting the macerating function of the macerator in the event that the toilet is deemed to be in use.

11. The macerator as claimed in claim 1, comprising a contactless switch for initiating the macerating function.

12. The macerator as claimed in claim 1, further comprising weighing means for weighing an article to be reduced.

13. The macerator as claimed in claim 1, comprising means for identifying an article to be reduced.

14. The macerator as claimed in claim 12, wherein the weighing means is located within the housing.

15. The macerator as claimed in claim 12, wherein the support plate is displaceable from an article support position to a position in which the article is not supported and is allowed to fall towards the area where it is to be reduced.

16. The macerator as claimed in claim 15, wherein the support plate is pivotally mounted.

17. The macerator as claimed in claim 12, wherein the opening is releasably closable.

18. The macerator as claimed in claim 12, further comprising means for identifying the article to be macerated, such as a scanner for reading a bar code associated with the article to be macerated or means for reading information from a radio frequency identification (RFID) tag on the article to be macerated.

19. A macerator comprising:
a housing;
an opening in the housing providing access to its interior;
an outlet located at a level below the opening;
reduction means within the housing for reducing a maceratable article; and
weighing means for weighing an article to be reduced.

20. A macerator comprising:
a housing;
an opening in the housing providing access to its interior;
an outlet located at a level below the opening;
reduction means within the housing for reducing maceratable articles; and
means for identifying an article to be macerated.
